(19) United States
(12) Patent Application Publication
(10) Pub. No.: US 2005/0076741 A1
(43) Pub. Date: Apr. 14, 2005

(54) Cork removing device

(75) Inventor: Sik-Leung Chan, New Territories (CN)

Correspondence Address: ALIX YALE & RISTAS LLP, 750 MAIN STREET, SUITE 1400, HARTFORD, CT, 06103, US

(73) Assignee: C. C. & L Company Limited

(21) Appl. No.: 10/682,282

(22) Filed: Oct. 9, 2003

(51) Int. Cl. B67B 7/00

(52) U.S. Cl. 81/3.2

(57) ABSTRACT

A cork removing device for removing a cork from the neck of a bottle includes a pressure chamber, a hollow needle having a tip and extending from the pressure chamber for penetrating the cork longitudinally thereby presenting its tip to the interior of the bottle. There is a plunger for repeatedly diminishing the volume of the pressure chamber using a pumping action. A valve is situated between the pressure chamber and the hollow needle for allowing the flow of air from the pressure chamber to the bottle upon movement of the plunger theretoward and for preventing a back-flow of air from the needle to the pressure chamber. A handgrip attached to the plunger encases the pressure chamber when the volume of the pressure chamber is at a minimum.

### BACKGROUND OF THE INVENTION

The present invention relates to cork removing devices. More particularly, although not exclusively, the invention relates to a cork removing device that increases the internal air pressure of a wine bottle to burst the cork from the bottle's neck.

A wide variety of wine bottle cork removers are known in the market. These comprise corkscrews, levers, pushers etc. Most cork removers require a degree of effort in first inserting a part of the device through the cork and secondly in extracting the cork. The use of many cork removers can result in severing of the cork into two or more pieces. This is particularly problematic with older wine bottles in which the cork has degraded.

### OBJECTS OF THE INVENTION

It is an object of the present invention to overcome or substantially ameliorate at least one of the above disadvantages and/or more generally to provide an improved cork removing device.

### DISCLOSURE OF THE INVENTION

There is disclosed herein a cork removing device for removing a cork from the neck of a bottle, comprising:
a pressure chamber,
a hollow needle having a tip and extending from the pressure chamber for penetrating the cork longitudinally thereby presenting its tip to the interior of the bottle,
a plunger for repeatedly diminishing the volume of the pressure chamber,
a valve situated between the pressure chamber and the hollow needle for allowing the flow of air from the pressure chamber upon movement of the plunger theretoward and for preventing a back-flow of air from the needle to the pressure chamber, and
a handgrip attached to the plunger and encasing the pressure chamber when the volume of the pressure chamber is at a minimum.

Preferably the plunger comprises a rod and a piston attached thereto, the piston comprising a one-way valve allowing the passage of air into the chamber upon a backstroke of the plunger.

Preferably the one-way valve comprises an annular recess in the piston within which there is situated an O-ring, the O-ring being movable longitudinally of the piston within the recess, the recess communicating with the chamber via an air passage.

Preferably the cork removing device a seal between the handgrip and the pressure chamber exterior.

Preferably the valve comprises a ball biased by a spring against a valve seat.

### BRIEF DESCRIPTION OF THE DRAWINGS

A preferred form of the present invention will now be described by way of example with reference to the accompanying drawings, wherein:

FIG. 1 is a schematic parts-exploded perspective illustration of a cork removing device,

FIG. 2 is a schematic cross-sectional elevation of the device of FIG. 1 when assembled and in a fully extended configuration in use near the end of an upstroke of its plunger,

FIG. 2a is a schematic cross-sectional detail diagram of a piston forming part of the cork removing device of FIG. 2,

FIG. 2b is a schematic cross-sectional detail diagram of a ball valve of the cork removing device during the piston upstroke,

FIG. 3 is a schematic cross-sectional elevation of the cork removing device in a fully retracted configuration in use,

FIG. 4 is another schematic cross-sectional elevation of the cork removing device in its extended configuration,

FIG. 5 is a schematic cross-sectional elevation of the cork removing device in a partially contracted configuration during a downstroke of its plunger,

FIG. 5a is a cross-sectional detail diagram of the piston of FIG. 5 during the piston downstroke, and

FIG. 5b is a schematic cross-sectional detail diagram of a ball valve of the cork removing device during the piston downstroke.

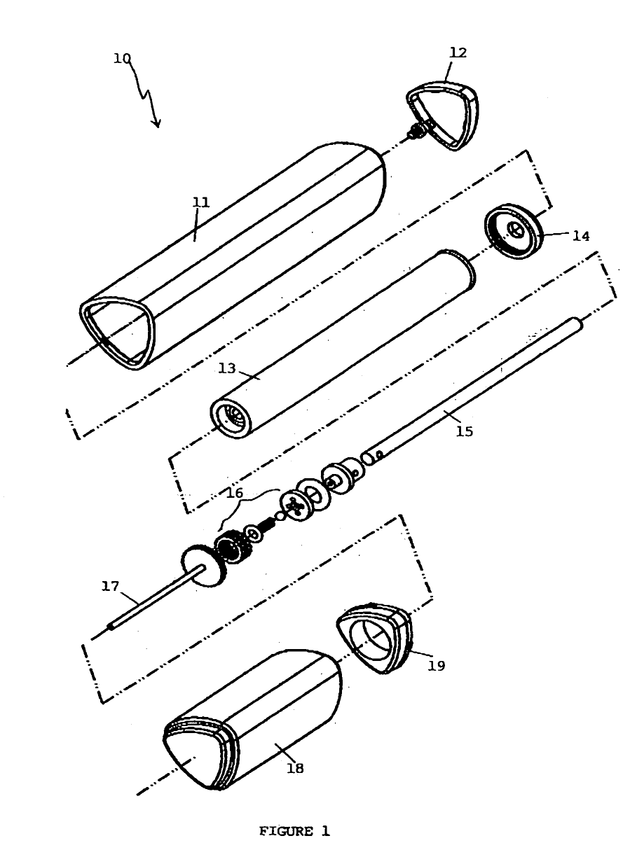

### DESCRIPTION OF THE PREFERRED EMBODIMENT

In the accompanying drawings there is depicted schematically a cork removing device 10. The device 10 comprises a hollow needle 17 attached by a ball valve assembly 16 to the end of a pressure chamber 13. Within the pressure chamber 13 there is provided a plunger 15 comprising a rod that passes through an end 14 of the pressure chamber and further includes a piston to be described later. There is a handgrip 11 attached by an end 12 to the plunger 15. At the forward end of the cork removing device, there is a protective cover 18 comprising and apertured plate 19 that fits over the needle 17 when the device is not in use.

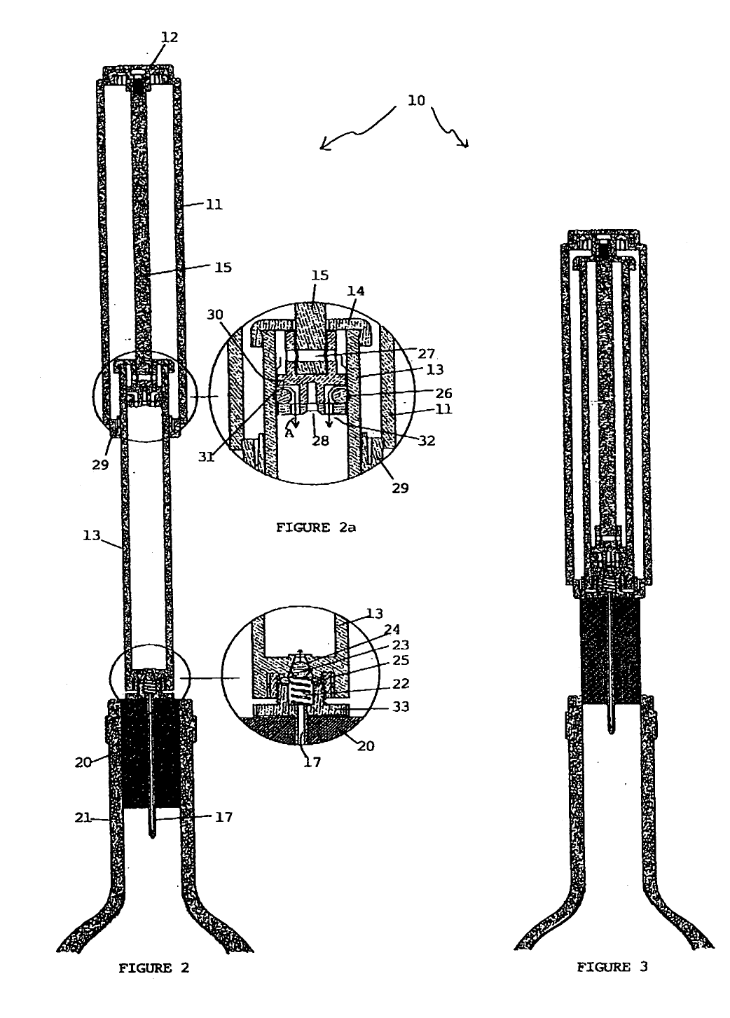

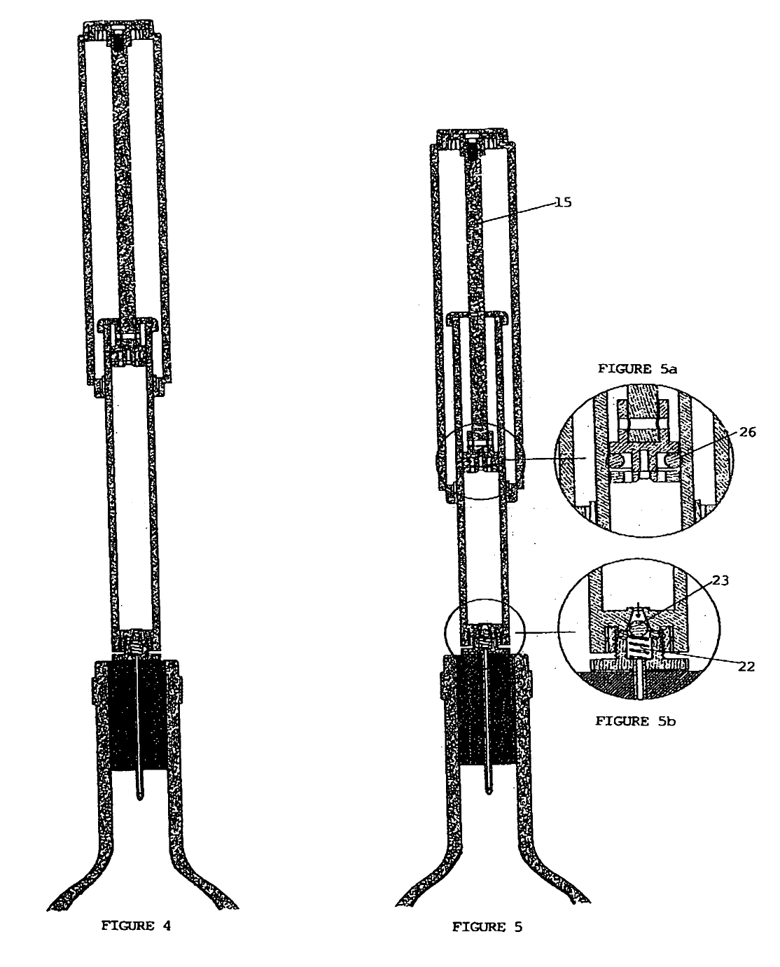

The plunger 15 comprises a rod at the end of which there is a transverse hole 27. Attached to the end of the rod is a piston 30 having a pair of holes aligned with the transverse hole 27 as shown in FIG. 2a. The piston 30 comprises an annulus 31 within which an O-ring 26 is received. The O-ring 26 is sized to bear outwardly against the inside surface of the pressure chamber 13, yet is dimensioned to be movable longitudinally within the annulus 31. There are air passages 32 at the bottom of the piston 30 via which air can pass as shown by the arrows A in FIG. 2a into the air pressure chamber 13 during an upstroke of the plunger 15. As evident in FIG. 2a, the O-ring 26 has moved down within the annulus 31 to allow the air to flow over the O-ring and through its centre.

As shown in FIG. 2b, the ball valve comprises a ball 23 located within a frusto-conical valve seat 24 at the bottom of the pressure chamber 13. A coil spring 22 is encapsulated in a threaded cap to which the needle 17 is attached. This spring biases the ball 23 into a closed position upon the valve seat 24 as shown during an upstroke of the plunger 15. There is a fixed O-ring seal 25 between the cap and the valve seat 24.

During a downstroke of the plunger 15, the O-ring 26 moves up within the annulus 31 to seal the piston 30 against the pressure chamber 13. As a result, air pressure within the pressure chamber 13 increases until pressure on the ball 23 exceeds the spring force exerted thereon by the coil spring 22.

In use, the protective cover 11 is removed from the device and the needle 17 is pushed downwardly through cork 20 at the neck of a wine bottle. The handgrip 11 can then simply be pumped up and down until the pressure beneath the cork 20 causes it to lift from the bottle. The cork might lift gradually upon each stroke of the plunger to burst from the bottleneck. The cork will not become a dangerous projectile as it will remain upon the needle 17 until it is removed therefrom.

It should be appreciated that modifications and alterations obvious to those skilled in the art are not to be considered as beyond the scope of the present invention. For example, instead of providing a removable protective 11, a retractable safety sleeve for example might be employed. Such a safety sleeve might have a bayonet lock by which it is attached to the device.

1. A cork removing device for removing a cork from the neck of a bottle, comprising:
a pressure chamber,
a hollow needle having a tip and extending from the pressure chamber for penetrating the cork longitudinally thereby presenting its tip to the interior of the bottle,
a plunger for repeatedly diminishing the volume of the pressure chamber,
a valve situated between the pressure chamber and the hollow needle for allowing the flow of air from the pressure chamber upon movement of the plunger theretoward and for preventing a back-flow of air from the needle to the pressure chamber, and
a handgrip attached to the plunger and encasing the pressure chamber when the volume of the pressure chamber is at a minimum.

2. The cork removing device of claim 1 wherein the plunger comprises a rod and a piston attached thereto, the piston comprising a one-way valve allowing the passage of air into the chamber upon a backstroke of the plunger.

3. The cork removing device of claim 2 wherein the one-way valve comprises an annular recess in the piston within which there is situated an O-ring, the O-ring being movable longitudinally of the piston within the recess, the recess communicating with the chamber via an air passage.

4. The cork removing device of claim 1 further comprising a seal between the handgrip and the pressure chamber exterior.

5. The cork removing device of claim 1 wherein the valve comprises a ball biased by a spring against a valve seat.
